(19) United States
(12) Patent Application Publication
(10) Pub. No.: US 2004/0017374 A1
(43) Pub. Date: Jan. 29, 2004

(54) Imaging data accessing method

(76) Inventors: Chi-Yang Lin, Taipei (TW); Macalas Yen, Taipei (TW); Wen-Lung Hsu, Taipei (TW); Jiing Lin, Taipei (TW)

Correspondence Address: MADSON & METCALF, GATEWAY TOWER WEST, SUITE 900, 15 WEST SOUTH TEMPLE, SALT LAKE CITY, UT, 84101

(21) Appl. No.: 10/615,765

(22) Filed: Jul. 9, 2003

(30) Foreign Application Priority Data
Jul. 25, 2002 (TW) 0911116629

(51) Int. Cl. G06F 13/14; G06F 15/167; G06T 11/40

(52) U.S. Cl. 345/541; 345/520; 345/552

(57) ABSTRACT

A method for accessing image data is used in a computer system. The computer system includes a core logic unit, a system memory, a graphics accelerator, and an image data outputting device in communication with a south bridge chip of the core logic unit. The method comprises the following steps. Firstly, image data are received from the image data outputting device by the core logic unit. Then, the image data are written into an AGP memory block of the system memory. Afterwards, the image data are accessed in the AGP memory block by the graphics accelerator.

### FIELD OF THE INVENTION

The present invention relates to a method for accessing image data, and more particularly to a method for accessing image data in a computer system.

### BACKGROUND OF THE INVENTION

In a conventional computer system of FIG. 1, a north bridge chip 11 and a south bridge chip 12 are used to control data flows among a microprocessor 10, a system memory 13, and a plurality of I/O devices including a graphics card 14. The microprocessor 10 accesses graphics data of the system memory 13 or outputs graphing commands to the graphics card 14 via the north bridge chip 11. The system memory 13 is usually a dynamic random access memory (DRAM) and comprises an AGP (Accelerated Graphics Port) memory 131. The graphics card 14 is electrically connected to the north bridge chip 11 via a PCI (Peripheral Component Interconnect) or AGP (Accelerated Graphics Port) bus, and comprises a graphics chip 141, a local memory 142 and an analog-to-digital (A/D) converter 143. The local memory 142 of the graphics card 14 is usually used as a frame buffer. Furthermore, the AGP memory 131 of the system memory 13 can be accessed by the graphics chip 141 in a directly access mode, and used as a texture buffer.

Nowadays, many electrical appliances are widely used with computers due to the amazing power of computers. So far, the image sources processed by a computer system include, for example, a TV tuner 15 and a USB camera 16. The analog signals from the TV tuner 15 are firstly transmitted to the graphics card 14 and converted into digital signals by the analog-to-digital converter 143. Then, the digital signals are transmitted to the graphics chip 141 via a specified protocol such as the one associated with a VIP, VM2 or ZA port to be processed. The processed image signals are written in the frame buffer of the local memory 142, and then read out to be displayed in an overlay mode. On the other hand, the image signals received from the USB camera 16 are processed by the south bridge chip 12. The processed image signals are written in a general memory block 132 other than the AGP memory 131 in the system memory 13 in a direct memory access (DMA) mode. When the processed image signals are to be displayed in a YUV bit block transfer mode for an overlay display purpose, the image signals have to be transferred from the general memory block to the AGP memory 131 first before they can be read and displayed by the graphics chip 141. It is apparently inefficient for resource utility as well as delayed data access.

### SUMMARY OF THE INVENTION

It is an object of the present invention to provide a method for accessing image data in a computer system, which omits the transfer from the general memory block to the AGP memory so as to accelerate the access of image data.

In accordance with a first aspect of the present invention, there is provided a method for accessing image data in a computer system. The computer system comprises a core logic unit, a system memory, a graphics accelerator, and an image data outputting device in communication with a south bridge chip of the core logic unit. The method comprises the following steps. Firstly, image data are received from the image data outputting device by the core logic unit. Then, the image data are written into an AGP memory block of the system memory. Afterwards, the image data are accessed in the AGP memory block by the graphics accelerator.

In an embodiment, the image data outputting device is a digital still camera or an optical disc drive.

In an embodiment, the image data from the image data outputting device are received by a south bridge chip of the core logic unit.

In an embodiment, the image data outputting device is electrically connected to the south bridge chip of the core logic unit via an interface selected from a group consisting of USB, IDE, IEEE1934, PCI and LAN interfaces.

In an embodiment, the image data in the AGP memory block of the system memory is accessed by the graphics accelerator as a texture.

In an embodiment, the AGP memory block of the system memory is in communication with a north bridge chip of the core logic unit via an AGP protocol.

In an embodiment, the graphics accelerator is electrically connected to the north bridge chip of the core logic unit via a PCI or an AGP bus.

Preferably, the step of writing the image data into the AGP memory block of the system memory is performed in a direct memory access mode.

In accordance with a second aspect of the present invention, there is provided a method for accessing image data in a computer system. The computer system comprises a core logic unit, a system memory, a graphics accelerator, and an image data outputting device in communication with a south bridge chip of the core logic unit. The method comprises the following steps. Firstly, image data are received, from the image data outputting device by the core logic unit. Then, the image are written data into a specified memory block of the system memory, which is accessible by the graphics accelerator in a direct memory access mode. Afterwards, the image data of the specified memory block are accessed by the graphics accelerator.

In an embodiment, the specified memory block is an AGP memory included in a system memory.

In accordance with a third aspect of the present invention, there is provided a method for accessing image data in a computer system. The computer system comprises a core logic unit, a system memory and a graphics accelerator. The method comprises the following steps. Firstly, data are received by the core logic unit. Then, a checking step is done to check whether the received data is image data. Then, the received data are written into a specified memory block of the system memory when the received data is image data afterwards, the received data are accessed in the specified memory block by the graphics accelerator.

In an embodiment, the data receiving and checking steps are performed by a south bridge chip of the core logic unit.

In an embodiment, the specified memory block of the system memory is a texture memory.

In an embodiment, the specified memory block of the system memory is an AGP memory.

The above objects and advantages of the present invention will become more readily apparent to those ordinarily skilled in the art after reviewing the following detailed description and accompanying drawings, in which:

### DESCRIPTION OF THE DRAWINGS

FIG. 1 is a block diagram showing the structure of a conventional computer system; and

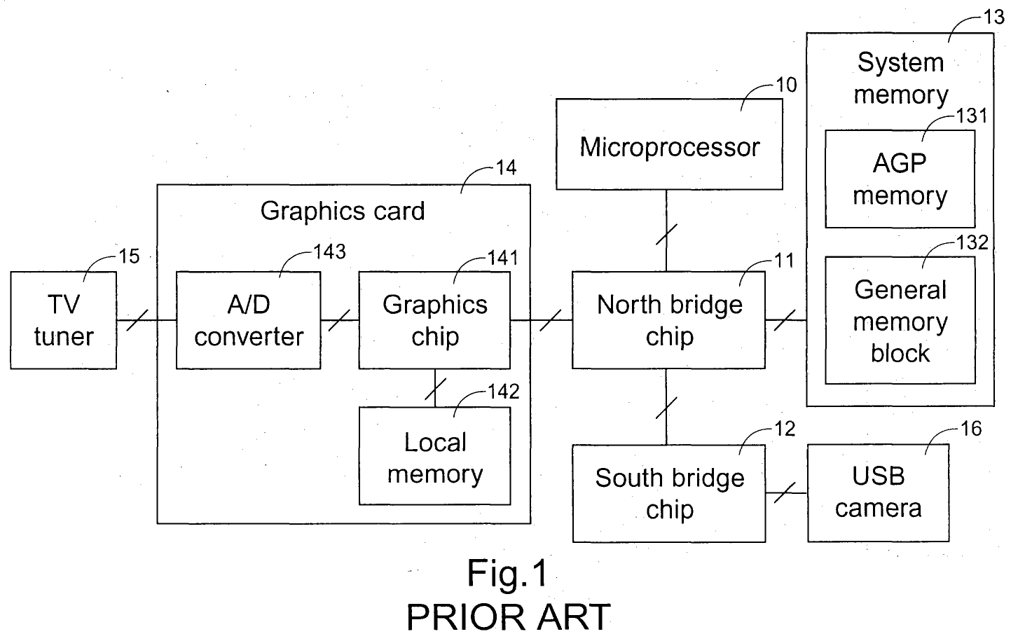

FIG. 2 is a block diagram showing the structure of a computer system to which a method for accessing image data according the present invention is applied.

### DETAILED DESCRIPTION OF THE PREFERRED EMBODIMENT

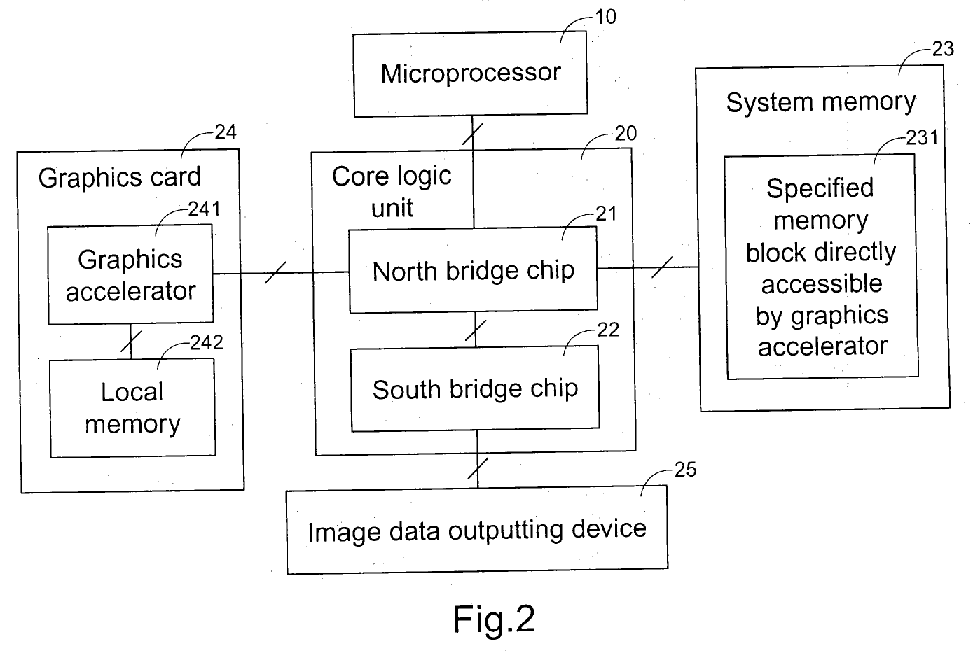

Referring to FIG. 2, the computer system comprises a microprocessor 10, a core logic unit 20, a system memory 23 and a graphics card 24. The core logic unit 20 comprises a north bridge chip 21 and a south bridge chip 22 and controls data flows among the microprocessor 20, the system memory 23, and a plurality of I/Q devices including the graphics card 24. The graphics card 24 is electrically connected to the north bridge chip 21 via a PCI (Peripheral Component Interconnect) or AGP (Accelerated Graphics Port) bus, and comprises a graphics accelerator 241 and a local memory 242. The system memory 23 is electrically connected to the north bridge chip 21 via a memory bus, and comprises a specified memory block 231 directly accessible by the graphics accelerator 241. The specified memory block 231 is for example an AGP memory, and used as a texture buffer.

The image data outputting device 25 is in communication with the south bridge chip 22 of the core logic unit 20 via an interface such as USB, IDE, IEEE1934, PCI or LAN interface. The image data outputting device 25, for example, can be a digital still camera or an optical disc drive.

The method for accessing image data according to the present invention will be illustrated as follows by referring to the computer system of FIG. 2.

When data, either compressed or non-compressed, are received by the core logic unit 20 via the south bridge chip 22, the data is checked whether to be image data or not. If positive, the image data are written into the specified memory block 231 of the system memory 23 in a direct memory access (DMA) mode. Accordingly, the graphics accelerator 241 can access the image data in the specified memory block 231 directly without any data transfer procedure as in the prior art performed in advance. For example, when the processed image data are to be displayed in a YUV bit block transfer mode for an overlay display purpose, the image data stored in the specified memory block 231 have been retrieved as a texture by the graphics accelerator 241 so as to be displayed on the screen. In such way, the transfer from the general memory block to the AGP memory will be omitted so as to accelerate the access of image data. The problem of inefficient resource utility and delayed data access will be overcome accordingly.

The identification of image data as mentioned above can be performed by the south bridge chip 22 of the core logic unit 20. If the received data is determined to be image data, the received data will be written into the specified memory block 231 of the system memory 23 in a direct memory access mode so as to be directly read and accessed by the graphics accelerator 241.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for accessing image data in a computer system, said computer system comprising a core logic unit, a system memory, a graphics accelerator, and an image data outputting device in communication with a south bridge chip of said core logic unit, said method comprising steps of:
receiving image data from said image data outputting device by said core logic unit;
writing said image data into an AGP memory block of said system memory; and
accessing said image data in said AGP memory block by said graphics accelerator.

2. The method according to claim 1 wherein said image data outputting device is a digital still camera or an optical disc drive.

3. The method according to claim 1 wherein said image data from said image data outputting device are received by a south bridge chip of said core logic unit.

4. The method according to claim 3 wherein said image data outputting device is electrically connected to said south bridge chip of said core logic unit via an interface selected from a group consisting of USB, IDE, IEEE1934, PCI and LAN interfaces.

5. The method according to claim 1 wherein said image data in said AGP memory block of said system memory is accessed by said graphics accelerator as a texture.

6. The method according to claim 1 wherein said AGP memory block of said system memory is in communication with a north bridge chip of said core logic unit via an AGP protocol.

7. The method according to claim 1 wherein said graphics accelerator is electrically connected to said north bridge chip of said core logic unit via a PCI or an AGP bus.

8. The method according to claim 1 wherein said step of writing said image data into said AGP memory block of said system memory is performed in a direct memory access mode.

9. A method for accessing image data in a computer system, said computer system comprising a core logic unit, a system memory, a graphics accelerator, and an image data outputting device in communication with a south bridge chip of said core logic unit, said method comprising steps of:
receiving image data from said image data outputting device by said core logic unit;
writing said image data into a specified memory block of said system memory, which is accessible by said graphics accelerator; and
accessing said image data of said specified memory block by said graphics accelerator.

10. The method according to claim 9 wherein said specified memory block is an AGP memory included in a system memory.

11. A method for accessing image data in a computer system, said computer system comprising a core logic unit, a system memory and a graphics accelerator, said method comprising steps of:
receiving data by said core logic unit;
checking whether said received data is image data;
writing said received data into a specified memory block of said system memory when said received data is image data; and
accessing said received data in said specified memory block by said graphics accelerator.

12. The method according to claim 11 wherein said data receiving and checking steps are performed by a south bridge chip of said core logic unit.

13. The method according to claim 11 wherein said specified memory block of said system memory is a texture memory.

14. The method according to claim 11 wherein said specified memory block of said system memory is an AGP memory.

15. The method according to claim 14 wherein said specified memory block of said system memory is in communication with a north bridge chip of said core logic unit via an AGP protocol.

16. The method according to claim 15 wherein said graphics accelerator is electrically connected to said north bridge chip of said core logic unit via a PCI or an AGP bus.

17. The method according to claim 11 wherein said step of writing said received data into said specified memory block of said system memory is performed in a direct memory access mode.
